(19) United States
(12) Patent Application Publication
(10) Pub. No.: US 2022/0066082 A1
(43) Pub. Date: Mar. 3, 2022

(54) Polarization Control Devices Using Cascaded Subwavelength Dielectric Gratings

(71) Applicant: THE REGENTS OF THE UNIVERSITY OF MICHIGAN, Ann Arbor, MI (US)

(72) Inventors: Steve YOUNG, Ann Arbor, MI (US); Anthony GRBIC, Ann Arbor, MI (US); Moshen JAFARI, Ann Arbor, MI (US)

(73) Assignee: THE REGENTS OF THE UNIVERSITY OF MICHIGAN, Ann Arbor, MI (US)

(21) Appl. No.: 17/464,825

(22) Filed: Sep. 2, 2021

Related U.S. Application Data
(60) Provisional application No. 63/073,997, filed on Sep. 3, 2020.

(51) Int. Cl. G02B 5/30; G02B 27/28

(52) U.S. Cl. CPC G02B 5/3041; G02B 27/281; G02B 5/3083

(57) ABSTRACT

Transmissive and reflective all-dielectric metastructures are presented that offer tailored polarization conversions and spectral responses. The metastructures consist of stacked deeply subwavelength, high contrast gratings of different fill factors and rotations. Broadband metastructures that perform a given polarization conversion over a wide continuous bandwidth will be shown, as well as multiband metastructures that perform a common polarization conversion over different bands. Unlike conventional stacked grating geometries, the transmissive metastructures do not require antireflection layers since impedance matching is incorporated into their design. The subwavelength gratings are modeled as homogeneous anisotropic layers, allowing an overall metastructure to be treated as a stratified dielectric medium. Quasi-static analysis is used to homogenize the subwavelength gratings and represent them with effective dielectric constants. Plane-wave transfer matrix techniques are employed to model the interactions between gratings, allowing for rapid design and optimization.

### CROSS-REFERENCE TO RELATED APPLICATION

This application claims the benefit of U.S. Provisional Application No. 63/073,997, filed on Sep. 3, 2020. The entire disclosure of the above application is incorporated herein by reference.

### GOVERNMENT CLAUSE

This invention was made with government support under N00014-15-1-2390 awarded by the Office of Naval Research and FA9550-18-1-0466 awarded by the U.S. Air Force. The government has certain rights in the invention.

### FIELD

The present disclosure relates to polarization control devices which use cascaded subwavelength dielectric gratings.

### BACKGROUND

Metasurfaces are optically-thin structures that can control the phase and polarization of electromagnetic waves through subwavelength patterning that tailors their electric, magnetic, and electro-magnetic/magneto-electric surface properties. While initial metasurfaces used metallic patterns, recent fabrication advances have enabled all-dielectric metasurfaces that can provide similar responses with significantly lower losses. Demonstrated dielectric elements include rods and fins that provide spatially varying phase and polarization shifts and silicon microdisks that use overlapping electric and magnetic resonances to provide reflectionless (Huygens') response.

Stacked or cascaded structures have also been proposed and demonstrated with strong bianisotropic responses, including circular dichroism and multifunction polarization conversion. Multilayer dielectric metasurfaces can also exhibit broadband or multichromatic operation. This disclosure presents polarization control devices comprised of cascaded subwavelength dielectric gratings to improve polarization control with varied spectral response.

This section provides background information related to the present disclosure which is not necessarily prior art.

### SUMMARY

This section provides a general summary of the disclosure, and is not a comprehensive disclosure of its full scope or all of its features.

A polarization control device is presented which operates on electromagnetic radiation at a given wavelength. The polarization control device is comprised of two or more metasurfaces stacked directly onto each other without intermediate layers interposed between the two or more metasurfaces. Each of the two or more metasurfaces has a grating structure formed by two dielectric materials, where a ratio of permittivity exhibited by the two dielectric materials is high and periodicity of the grating structure is less than the given wavelength. The orientation of the grating structure in each of the two or more metasurfaces also differs from each of the other grating structures in the two or more metasurfaces.

In some embodiments, the ratio of permittivity exhibited by the two dielectric materials is greater than four.

In some embodiments, the periodicity of the grating structure is less than the quotient of the given wavelength divided by five.

The filling fraction of the grating structure is preferably between twenty and one hundred percent.

In some embodiments, each of the two or more metasurfaces has a thickness in range of λ/20 and λ/4, where λ is the given wavelength.

The polarization control device may be design to perform different functions. In one instance, the polarization control device operates to rotate polarization state of light incident thereon. In another instance, the polarization control device operates to rotate polarization state of light incident thereon by a fixed angle independent of the angle of incidence. In yet another instance, the polarization control device operates to transmit light incident thereon as left-circular polarized in a first frequency band and to transmit the light incident thereon as right-circular polarized in a second frequency band, where the first frequency band does not overlap with the second frequency band.

The polarization control device is preferably fabricated using additive manufacturing.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating a subwavelength grating layer and its equivalent anisotropic slab with permittivities.

FIG. 2 is a diagram illustrating a plane wave obliquely incident on a stratified slab consisting of N uniform layers.

FIG. 3 is an exploded view of polarization control device composed of a stack of dielectric gratings with different crystal axis orientations.

FIG. 4 is a perspective view of an example half-wave plate.

FIGS. 5A and 5B are graphs showing the measured (solid) and analytically calculated (dotted) reflection coefficients with an incident angle at zero and forty-five degrees.

FIG. 5C is a graph showing the measured (solid) and analytically calculated (dotted) phase performance with an incident angle at zero.

FIG. 5D is a graph showing the polarization rotation at 33 GHz as a function of waveplate angle.

FIG. 6 is a cutaway view of an example isotropic polarization rotator.

FIG. 7A is graph showing the analytically calculated transmission coefficients for the desired and cross polarizations with the incident polarization angle varied from zero to ninety degrees.

FIG. 7B is graph showing the measured transmission coefficients for the desired and cross polarizations with the incident polarization angle varied from zero to ninety degrees.

FIG. 8 is a cutaway view of an example dual band circular polarizer.

FIG. 9 is a graph showing the analytically calculated transmission coefficients and axial ratio for the dual band circular polarizer.

FIG. 10 is a schematic of a stereolithography process which may be used to fabricate polarization control devices.

Corresponding reference numerals indicate corresponding parts throughout the several views of the drawings.

### DETAILED DESCRIPTION

Example embodiments will now be described more fully with reference to the accompanying drawings.

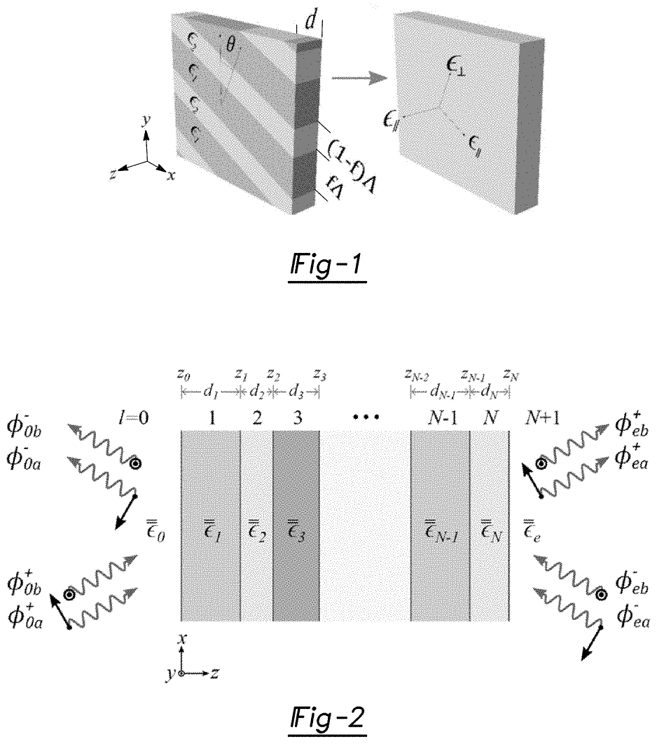

FIG. 1 illustrates a subwavelength grating layer and its equivalent anisotropic slab with permittivities. When the grating period is much smaller than the free space wavelength λ₀, each subwavelength grating can be treated as a rotated uniaxial homogeneous slab as illustrated in FIG. 1, with permittivities as follows:

$$\frac{1}{{ϵ}_{⊥}} = \frac{f}{{ϵ}_{1}} + \frac{1 - f}{{ϵ}_{2}} , {ϵ}_{∥} = {f ϵ}_{1} + ( 1 - f ) {ϵ}_{2} \qquad ( 1 )$$

where ε_{⊥} and ε_{∥} are the effective permittivity along the grating's extraordinary and ordinary optic axes, and f is the filling ratio of medium 1. After homogenizing each layer in this way, the plane wave transmission and reflection performance for the cascaded structure can be rapidly calculated using analytic transfer matrix techniques for layered media. A wide range of desired responses can then be achieved by numerically optimizing three parameters per layer: fill factor fₗ, layer thickness dₗand optic axis rotation angle θₗ.

With reference to FIG. 2, the reflection and transmission of monochromatic plane waves through the stratified structure are considered. The stratified structure consists of N cascaded subwavelength grating layers. For deeply subwavelength gratings with negligible contribution from higher-order Floquet harmonics, 4×4 matrix techniques are sufficient to compute the exact response, including multiple reflections and polarization conversion. A special case of the 4×4 matrix technique for nonmagnetic anisotropic media with oblique incidence is described below.

Applying the homogenization procedure, each layer is treated as a nonmagnetic, uniaxial homogeneous medium with principal axes rotated by an angle θₗ in the xy-plane. The constitutive relation in each layer is then:

$$( \begin{matrix}{ɛ}_{0} \overline{ϵ} & 0 \\ 0 & {μ}_{0} I\end{matrix} ) ( \begin{matrix}E \\ H\end{matrix} ) = ( \begin{matrix}D \\ B\end{matrix} ) \qquad ( 2 )$$

where I is the 3×3 identity matrix, and ϵ̅ is given by:

$$\overline{ϵ} = ( \begin{matrix}\begin{matrix}{ϵ}_{xx} \\ {ϵ}_{yx}\end{matrix} \\ 0\end{matrix} \begin{matrix}\begin{matrix}{ϵ}_{xy} \\ {ϵ}_{yy}\end{matrix} \\ 0\end{matrix} \begin{matrix}\begin{matrix}0 \\ 0\end{matrix} \\ {ϵ}_{zz}\end{matrix} ) = ( \begin{matrix}\begin{matrix}{ϵ}_{∥} {cos}^{2} {θ}_{l} + {ϵ}_{⊥} {sin}^{2} {θ}_{l} \\ ( {ϵ}_{∥} - {ϵ}_{⊥} ) cos {θ}_{l} sin {θ}_{l}\end{matrix} \\ 0\end{matrix} \begin{matrix}\begin{matrix}( {ϵ}_{∥} - {ϵ}_{⊥} ) cos {θ}_{l} sin {θ}_{l} \\ {ϵ}_{∥} {sin}^{2} {θ}_{l} + {ϵ}_{⊥} {cos}^{2} {θ}_{l}\end{matrix} \\ 0\end{matrix} \begin{matrix}\begin{matrix}0 \\ 0\end{matrix} \\ {ϵ}_{∥}\end{matrix} ) \qquad ( 3 )$$

Beginning with Faraday's Law and Ampere's Law in source-free media:

$$\begin{matrix}∇ ⨯ E = - \frac{\partial B}{\partial t} & ( 4 ) \\ ∇ ⨯ H = \frac{\partial D}{\partial t} & ( 5 )\end{matrix}$$

Considering monochromatic fields with exp(jωt) time evolution, in Cartesian coordinates, one can write these in a matrix form:

$$( \begin{matrix}0 & ∇ ⨯ \\ - ∇ ⨯ & 0\end{matrix} ) ( \begin{matrix}E \\ H\end{matrix} ) = j ω ( \begin{matrix}D \\ B\end{matrix} ) \qquad ( 6 )$$

If the material properties depend only on z, plane wave fields have the form A(z)e^{-jk}^{ₓ}^{x} e^{-jk}^{_{y}}^{y} e^{jωt} and the curl operator has the form:

$$∇ ⨯ = ( \begin{matrix}\begin{matrix}0 \\ \frac{\partial }{\partial z}\end{matrix} \\ {jk}_{y}\end{matrix} \begin{matrix}\begin{matrix}- \frac{\partial }{\partial z} \\ 0\end{matrix} \\ - {jk}_{x}\end{matrix} \begin{matrix}\begin{matrix}- {jk}_{y} \\ {jk}_{x}\end{matrix} \\ 0\end{matrix} ) \qquad ( 7 )$$

Combining equations 2, 6 and 7 yields a system of six equations, of which the third and sixth are linear algebraic equations relating the six components of E and H. These can be solved for Ez and Hz in terms of the other four components, yielding the following 4×4 wave equation for the transverse field:

$${k}_{0}^{2} \frac{\partial }{\partial z} ( \begin{matrix}\begin{matrix}\begin{matrix}{E}_{x} \\ {E}_{y}\end{matrix} \\ {H}_{x}\end{matrix} \\ {H}_{y}\end{matrix} ) = - j ω ( \begin{matrix}\begin{matrix}\begin{matrix}0 \\ 0\end{matrix} \\ - {ϵ}_{0} ( {k}_{0}^{2} {ϵ}_{yx} + {k}_{x} {k}_{y} )\end{matrix} \\ {ϵ}_{0} ( {k}_{0}^{2} {ϵ}_{xx} - {k}_{y}^{2} )\end{matrix} \begin{matrix}\begin{matrix}\begin{matrix}0 \\ 0\end{matrix} \\ - {ϵ}_{0} ( {k}_{0}^{2} {ϵ}_{yy} - {k}_{x}^{2} )\end{matrix} \\ {ϵ}_{0} ( {k}_{y}^{2} {ϵ}_{xy} + {k}_{x} {k}_{y} )\end{matrix} \begin{matrix}\begin{matrix}\begin{matrix}{μ}_{0} {k}_{x} {k}_{y} / {ϵ}_{aa} \\ - {μ}_{0} ( {k}_{0}^{2} - {k}_{y}^{2} / {ϵ}_{xx} )\end{matrix} \\ 0\end{matrix} \\ 0\end{matrix} \begin{matrix}\begin{matrix}\begin{matrix}{μ}_{0} ( {k}_{y}^{2} - {k}_{x}^{2} / {ϵ}_{xx} ) \\ - {μ}_{0} {k}_{x} {k}_{y} / {ϵ}_{xx}\end{matrix} \\ 0\end{matrix} \\ 0\end{matrix} ) ( \begin{matrix}\begin{matrix}\begin{matrix}{E}_{x} \\ {E}_{y}\end{matrix} \\ {H}_{x}\end{matrix} \\ {H}_{y}\end{matrix} ) \qquad ( 8 )$$

Noting that the structure is piecewise uniform and the material properties do not depend on z within each layer, equation 8 has four solutions for the total transverse field vector ψₗ=(Ex, Ey, Hx, Hy) of the form

$${ψ}_{ln} ( {z}_{0} + {δ}_{z} ) = \text{?} {ψ}_{ln} ( {z}_{0} ) , n = 1 , 2 , 3 , 4 \\ \text{?} \text{indicates text missing or illegible when filed} \qquad ( 9 )$$

which when substituted in equation 8 yields the eigenvalue equation:

$${q}_{ln} {ψ}_{ln} = {Λ}_{l} {ψ}_{ln} \qquad ( 10 )$$

Equation 10 can be solved numerically for each layer to find the four characteristic propagation constants qₗₙ and associated eigenmodes ψₗₙ. In general, the total transverse field ψₗ at a given position z within the structure can be decomposed into a weighted superposition of the eigenmodes with weights ϕₗ=(ϕ₁, ϕ₂, ϕ₃, ϕ₄)^{T}. The total field and mode amplitudes are related by

$${ψ}_{l} ( z ) = {A}_{l} {ϕ}_{l} ( z ) \qquad ( 11 )$$

where Aₗ=(ψₗ₁, ψₗ₂, ψ₁₃, ψₗ₄) is a weighting matrix whose columns are the eigenmodes of Λₗ. The vector of mode amplitudes evolves within each layer according to a propagation matrix Kₗ̅.

$${ϕ}_{l} ( z ) = {K}_{l}^{-} {ϕ}_{l} ( z + d ) = ( \begin{matrix}\begin{matrix}\begin{matrix}{e}^{{jq 11}^{d}} \\ 0\end{matrix} \\ 0\end{matrix} \\ 0\end{matrix} \begin{matrix}\begin{matrix}\begin{matrix}0 \\ {e}^{{jq 12}^{d}}\end{matrix} \\ 0\end{matrix} \\ 0\end{matrix} \begin{matrix}\begin{matrix}\begin{matrix}0 \\ 0\end{matrix} \\ {e}^{{jq 13}^{d}}\end{matrix} \\ 0\end{matrix} \begin{matrix}\begin{matrix}\begin{matrix}0 \\ 0\end{matrix} \\ 0\end{matrix} \\ {e}^{{jq 14}^{d}}\end{matrix} ) {ϕ}_{l} ( z + d ) \qquad ( 9 )$$

Finally, by combining equations 11 and 12 and enforcing that the transverse fields must match across each layer boundary, a wave matrix W can be constructed relating the mode amplitudes on either side of the cascaded structure. Ordering the modes in the incident and exit media according to their polarization and propagation direction as depicted in FIG. 2,

$${( \begin{matrix}\begin{matrix}\begin{matrix}{ϕ}_{0 a}^{+} \\ {ϕ}_{0 b}^{+}\end{matrix} \\ {ϕ}_{0 a}^{-}\end{matrix} \\ {ϕ}_{0 b}^{-}\end{matrix} )}_{x = xy} = {{A}_{0}}^{- 3} ( {A}_{1} {K}_{1}^{-} ( {d}_{1} ) {{A}_{1}}^{- 1} ) ( {A}_{3} {K}_{1}^{-} ( {d}_{2} ) {{A}_{2}}^{- 1} ) … ( {A}_{N} {K}_{N}^{-} ( {d}_{N} ) {{A}_{N}}^{- 1} ) {{A}_{e} ( \begin{matrix}\begin{matrix}\begin{matrix}{ϕ}_{ea}^{+} \\ {ϕ}_{eb}^{+}\end{matrix} \\ {ϕ}_{ea}^{-}\end{matrix} \\ {ϕ}_{eb}^{-}\end{matrix} )}_{x = xN} = ( \begin{matrix}{W}_{11} & {W}_{12} \\ {W}_{21} & {W}_{22}\end{matrix} ) {{A}_{e} ( \begin{matrix}\begin{matrix}\begin{matrix}{ϕ}_{ea}^{+} \\ {ϕ}_{eb}^{+}\end{matrix} \\ {ϕ}_{oa}^{-}\end{matrix} \\ {ϕ}_{ob}^{-}\end{matrix} )}_{x = xN} \qquad ( 13 )$$

The transmission and reflection coefficients for the cascaded structure are most conveniently represented by the scattering matrix S, which relates scattered to incident mode amplitudes. The scattering matrix can be obtained from the wave matrix as follows:

$$( \begin{matrix}\begin{matrix}\begin{matrix}{ϕ}_{0 a}^{-} \\ {ϕ}_{0 b}^{-}\end{matrix} \\ {ϕ}_{ea}^{-}\end{matrix} \\ {ϕ}_{eb}^{-}\end{matrix} ) = ( \begin{matrix}{S}_{11} & {S}_{12} \\ {S}_{21} & {S}_{22}\end{matrix} ) ( \begin{matrix}\begin{matrix}\begin{matrix}{ϕ}_{0 a}^{+} \\ {ϕ}_{0 b}^{+}\end{matrix} \\ {ϕ}_{ea}^{-}\end{matrix} \\ {ϕ}_{eb}^{-}\end{matrix} ) = {( \begin{matrix}0 & {W}_{11} \\ - I & {W}_{21}\end{matrix} )}^{- 1} ( \begin{matrix}I & - {W}_{12} \\ 0 & - {W}_{22}\end{matrix} ) ( \begin{matrix}\begin{matrix}\begin{matrix}{ϕ}_{0 a}^{+} \\ {ϕ}_{0 b}^{+}\end{matrix} \\ {ϕ}_{ea}^{-}\end{matrix} \\ {ϕ}_{eb}^{-}\end{matrix} ) \qquad ( 14 )$$

Given the grating parameters for each layer (grating materials, filling fraction fₗ, layer thickness d₁ and optic axis rotation angle θₗ), the transfer matrix analysis method described above allows computing the scattering matrix extremely quickly by simply multiplying several 4×4 matrices. Thus, the computation can be included within the cost function for a numerical optimization to obtain a wide range of polarization and spectral responses, including broadband, multiband, and multifunctional devices.

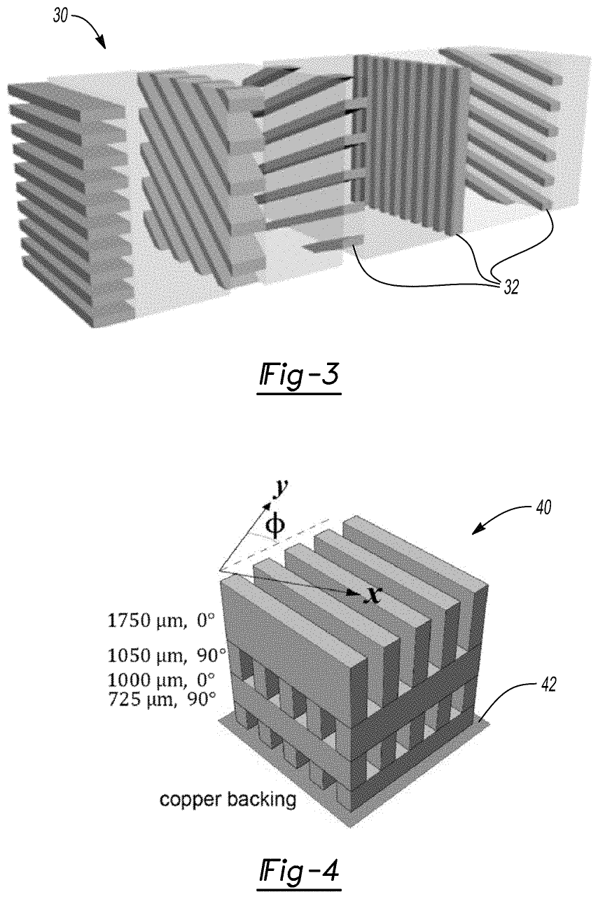

FIG. 3 depicts an example of a polarization control device 30 constructed in accordance with the design method described above. The polarization control device 30 is designed to operate on electromagnetic radiation at a given wavelength (or range of wavelengths). The polarization control device is comprised generally of two or more metasurfaces 32 stacked directly onto each other without intermediate layers interposed between the two or more metasurfaces. The orientation of a given grating structure in the two or more metasurfaces 32 preferably differs from the orientation of each of the other grating structures in the two or more metasurfaces.

Each of the two or more metasurfaces 32 has a grating structure formed by two dielectric materials, where the ratio of permittivity exhibited by the two dielectric materials is high and the periodicity of the grating structure is less than the given operating wavelength (λ). In example embodiments, the ratio of permittivity exhibited by the two dielectric materials is greater than four and the periodicity of the grating structure is less than a quotient of the given wavelength divided by five (i.e., periodicity<λ/5). By way of example, the two dielectric materials can be alumina and air. In this example, the ratio of permittivity is on the order of 9, where the permittivity of alumina is 9.7 and the permittivity of air is about one. For a polarization control device operating in the Ka band (26.5-40 GHz), the grating periodicity is less than 1500 microns. While particular reference is made to alumina and air, it is readily understood that different types of dielectric materials fall within the scope of this disclosure.

Additionally, each of the two or more metasurfaces 32 has a thickness in range of λ/20 and λ/4, where λ is the given operating wavelength. In the example embodiments, the filling fraction of the grating structure is preferably between twenty and one hundred percent. These particular parameters are merely illustrative and other values falling within the specified limits are contemplated by this disclosure. Different examples and implementations for such polarization control devices are further described below.

FIG. 4 depicts an example of half-wave plate 40 constructed in accordance with this disclosure. The reflective half-wave plate 40 operates in the Kₐ band (26.5-40 GHz) and was fabricated using ceramic stereolithography with alumina (ϵ₁=9.7, tan δ₁=10⁻⁴) and air (ϵ₂=1) subwavelength gratings backed by a copper plate 42. The desired reflection tensor for a half-wave plate is (using e^{jωt} time evolution):

$$( \begin{matrix}{E}_{x}^{-} \\ {E}_{y}^{-}\end{matrix} ) = {S}_{11} ( \begin{matrix}{E}_{x}^{+} \\ {E}_{y}^{+}\end{matrix} ) = {e}^{j φ} ( \begin{matrix}1 \\ 0\end{matrix} \begin{matrix}0 \\ - 1\end{matrix} ) ( \begin{matrix}{E}_{x}^{+} \\ {E}_{y}^{+}\end{matrix} ) \qquad ( 15 )$$

where φ is an arbitrary constant phase shift.

For simplicity, a filling fraction fₗ=0.5 was fixed for each layer, with grating period Λ=1000 μm to give Λ/λ₀<0.13. The layer thicknesses dₗ and optic axis rotation angles θₗ were numerically optimized to minimize the difference between the desired (equation (15)) and analytically calculated reflection tensors over the operating band. In this example, four metasurfaces are stacked directly onto each other. Layer thicknesses are as follows: 1750 μm; 1050 μm; 1000 μm and 725 μm. Using more layers widens the bandwidth at the cost of more complexity. In the end, four layers were chosen as a reasonable trade-off to yield the design.

As proof of concept, the half-wave plate 40 was fabricated by Technology Assessment & Transfer, Inc. using a ceramic stereolithography process. A resin was prepared consisting of sinterable alumina powder, a monomer/initiator mixture, and dispersants. The resin was photocured layer-by-layer as in conventional stereolithography to produce a green state part, which was then thermally processed to remove the binder, and sintered. During sintering the part shrinks in a predictable manner by approximately 20%, which is compensated by scaling the design appropriately. The fabricated half-wave plate 40 is a disk approximately 9 cm in diameter.

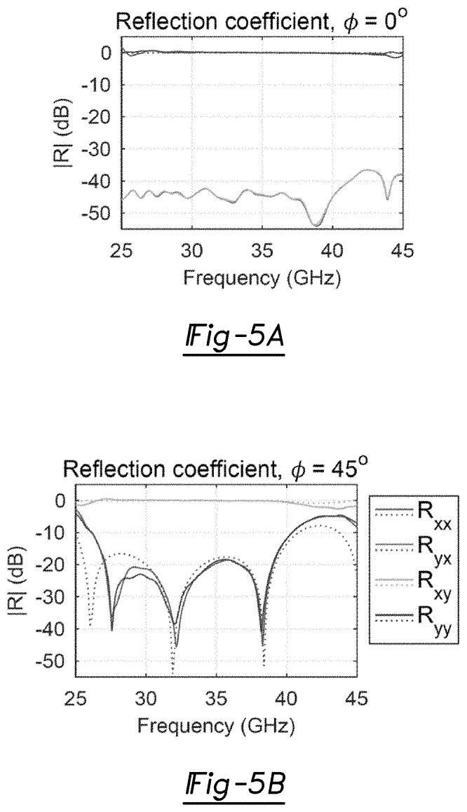

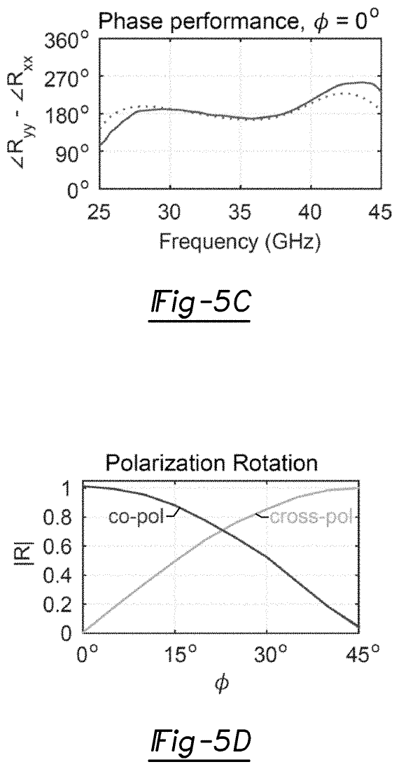

FIGS. 5A-5D show the measured half-wave plate 40 performance, demonstrating the expected half-wave plate polarization performance and low loss over the entire 26.5-40 GHz operating band. Excitation is at normal incidence with linear polarization along x and y. The co-polarized and cross-polarized reflection performance was measured in the 25-45 GHz range using a dual linearly polarized Gaussian optic antenna and vector network analyzer. The antenna produces a 3.8 cm diameter beam waist at 33 GHz. The half-wave plate was placed at the focal plane and illuminated at normal incidence. A rotation mount was used to adjust the angle φ of the fast optic axis, and the reflection tensor was measured. The round-trip path loss and delay for each polarization component was also characterized using a copper sheet (short standard) and used to normalize and de-embed the device measurements.

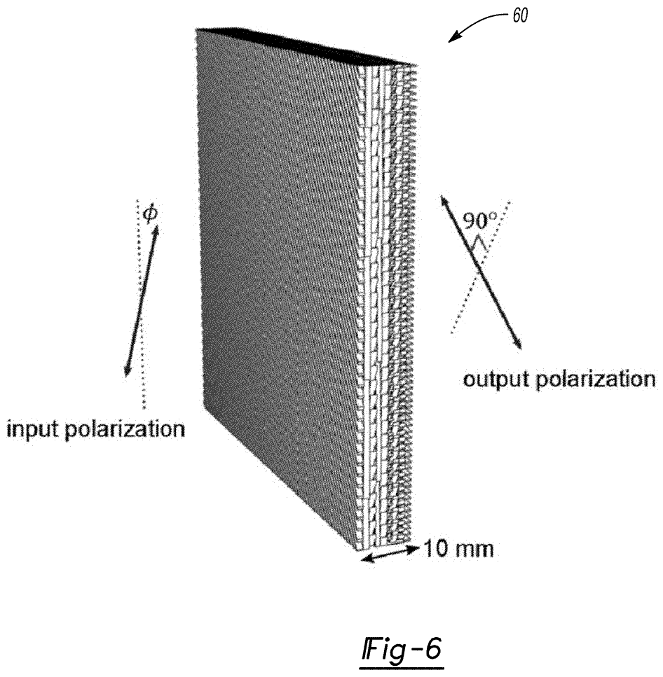

FIG. 6 depicts an example of an isotropic polarization rotator 60 constructed in accordance with this disclosure. The polarization rotator is ideally characterized by the transmission tensor:

$$( \begin{matrix}{E}_{ex}^{+} \\ {E}_{ey}^{+}\end{matrix} ) = {S}_{21} ( \begin{matrix}{E}_{0 x}^{+} \\ {E}_{0 y}^{+}\end{matrix} ) = {e}^{j φ} ( \begin{matrix}cos α \\ sin α\end{matrix} \begin{matrix}- sin α \\ cos α\end{matrix} ) ( \begin{matrix}{E}_{0 x}^{+} \\ {E}_{0 y}^{+}\end{matrix} ) \qquad ( 16 )$$

where φ is an arbitrary constant phase shift. That is, linearly polarized incident light is transmitted without reflection, and the transmitted polarization is rotated counterclockwise by an angle α. In contrast to the half-wave plate 40, which can rotate only specific linearly polarizations, the isotropic polarization rotator 60 produces the same rotation angle regardless of the incident polarization. Isotropic rotation is an inherently chiral response and therefore is a more demanding design challenge than a half-wave plate.

In one example, the polarization rotator 60 was designed to provide α=90° rotation from 30-35 GHz within the Ka band using alumina (ϵ₁=9.7, tan δ₁=10⁻⁴) and air (ϵ₂=1) subwavelength gratings. The grating period was fixed at Λ=1100 μm, while the filling fraction fₗ, layer thicknesses dₗ and optic axis rotation angles θₗ for each layer were numerically optimized to minimize the difference between the desired and analytically calculated transmission tensors. The optimization was repeated with an increasing number of layers until good results were achieved at all incident polarizations over the target frequency band.

Specifically, the design resulted in a polarization control device comprising nine (9) subwavelength grating layers with total thickness of 10.1 mm (about 0.85 λ₀). Starting at front layer, layer thickness in microns (μm) is 1160, 1120, 1200, 920, 1240, 920, 1200, 1120, 1160; whereas, starting with the front layer, the grating angle in degrees is 0, 30, 60, 30, 62, 93, 64, 93, 124. Starting again with the front layer, the filling fraction for each layer is 0.30, 0.65, 0.36, 0.38, 0.65, 0.38, 0.36, 0.65, 0.30. While an exemplary embodiment for a polarization rotator has been described above with specific values and arranged in a specific configuration, it will be appreciated that these devices may be constructed with many different configurations and/or values as necessary or desired for a particular application. The above configurations, components and values are presented only to describe one particular embodiment that has proven effective and should be viewed as illustrating, rather than limiting, the present disclosure.

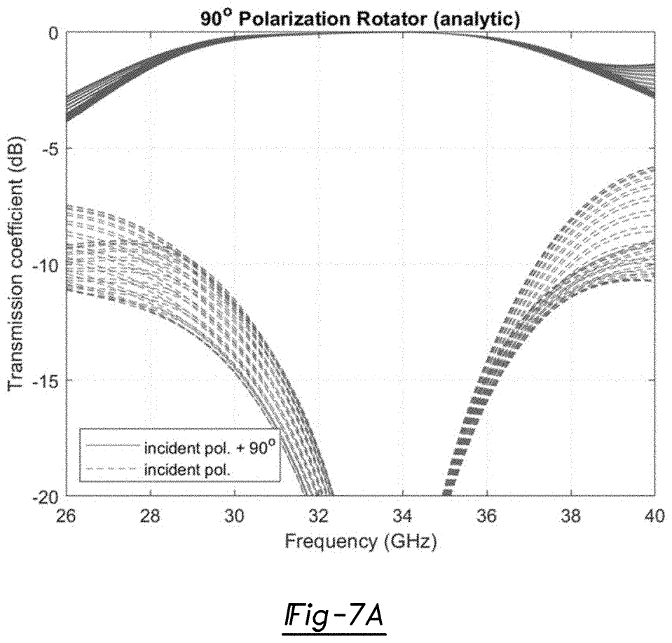

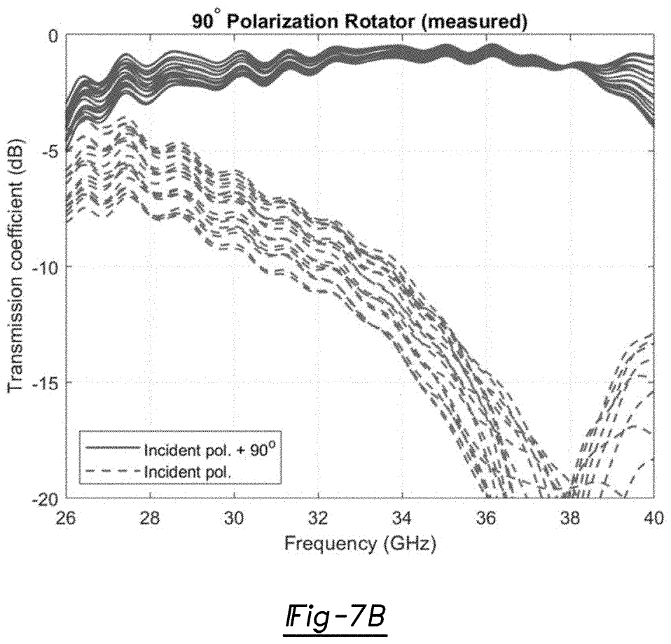

FIG. 7A shows the analytically calculated results for the polarization rotator 60 with the incident angle varied from 0≤φ≤90 degrees. As seen in the figure, the grating-based design not only provides the desired polarization rotation but incorporates impedance matching allowing for reflectionless operation without needing additional antireflection coatings. For this example, the polarization rotator 60 was fabricated by Technology Assessment & Transfer, Inc. using a ceramic stereolithography process. FIG. 7B shows measured transmission performance validating the analytic calculations.

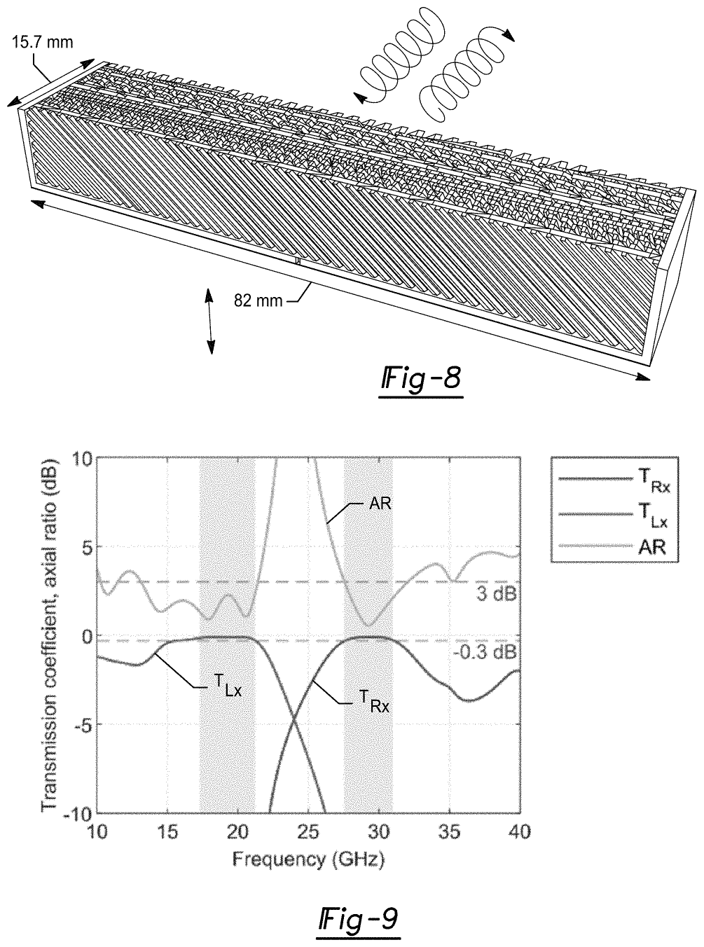

FIG. 8 depicts an example of a dual band circular polarizer 80 constructed in accordance with this disclosure. Ka band communication satellites typically use two circularly polarized bands. Thus, the dual band circular polarizer is design to produce both circular polarized bands with a single linear polarized feed. That is, incident light on the circular polarizer 80 is transmitted at left-circular polarized in a lower frequency band (e.g., 17.3-21.2 GHz) and right-circular polarized in the upper frequency band (e.g., 27.5-31.0 GHz).

Similar to the polarization rotator, each grating layer's thickness, filling fraction and orientation were allowed to vary as design parameters. In one embodiment, the dual band circular polarizer is comprised of sixteen (16) subwavelength grating layers with total thickness of 15.7 mm. Starting at front layer, layer thickness in microns (μm) is 400, 1100, 1200, 1000, 650, 1200, 1200, 500, 1200, 1200, 950, 600, 1200, 900, 1200 and 1200; whereas, starting with the front layer, the grating angle in degrees is 121, 81, 22, 52, 99, 28, 69, 39, 9, 53, 23, 141, 111, 30, 93, and 63. Starting again with the front layer, the filling fraction for each layer is 0.55, 0.59, 0.30, 0.70, 0.46, 0.40, 0.30, 0.70, 0.30, 0.52, 0.70, 0.46, 0.70, 0.30 and 0.30. While an exemplary embodiment for a circular polarizer has been described above with specific values and arranged in a specific configuration, it will be appreciated that these devices may be constructed with many different configurations and/or values as necessary or desired for a particular application. The above configurations, components and values are presented only to describe one particular embodiment that has proven effective and should be viewed as illustrating, rather than limiting, the present disclosure.

FIG. 9 shows the analytically calculated performance for the proposed device, demonstrating less than 3 dB axial ratio and low insertion loss over the entirety of both uplink and downlink bands. Near unity transmission efficiency is achieved without the need for additional antireflection layers, since impedance matching is integrated into the design. Such circular polarizer 80 could find use as the enabling component of a low-profile, wide-angle transceiver for high-throughput satellite radios. The multifunctional circular polarizer would significantly simplify the radio antenna design by allowing the use of a single, broadband, linearly polarized antenna for both uplink and downlink. The circular polarizer could be envisioned in ground-based pack mount or vehicle mount applications, or as part of the space-based satellite antenna system.

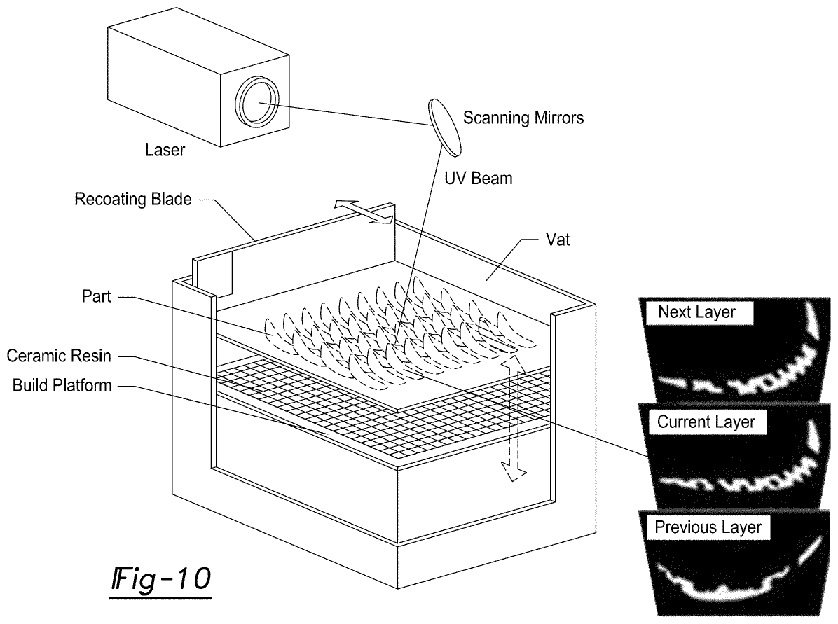

Stereolithography was developed by 3D Systems, Inc. and is a widely used 3D printing process that builds parts using a liquid photocurable resin and a scanned UV laser or projected UV image. FIG. 10 shows a schematic of a printing process in which parts are built on a platform situated in a vat of liquid resin. This printing process may be used to construct the polarization control devices described herein. The projected image exposes the desired parts of each layer, polymerizing the resin upon exposure and bonding it to either the platform (first layer) or the previous layer. In this configuration, fine voxel resolution (˜50 microns [0.002 inches]) and liquid resin material provides the best combination of build speed, fine feature resolution, and smooth surface finish as compared to other 3D printing processes. The parts, whether on the easier up-facing surfaces or more difficult sidewall surfaces, exhibit crisp edges and smooth surfaces. These advantages observed in polymer printing carry-over to use of these processes for ceramic printing and are important attributes for printing devices with complex geometries. While ceramic stereolithography is suitable for constructing polarization control devices described herein, other types of 3D printing processes or additive manufacturing techniques also fall within the scope of this disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A polarization control device operating on electromagnetic radiation at a given wavelength, comprising:
two or more metasurfaces stacked directly onto each other without intermediate layers interposed between the two or more metasurfaces;
each of the two or more metasurfaces has a grating structure formed by two dielectric materials, where a ratio of permittivity exhibited by the two dielectric materials is high and periodicity of the grating structure is less than the given wavelength; and
wherein orientation of the grating structure in each of the two or more metasurfaces differs from each of the other grating structures in the two or more metasurfaces.

2. The polarization control device of claim 1 wherein the ratio of permittivity exhibited by the two dielectric materials is greater than four.

3. The polarization control device of claim 1 wherein the periodicity of the grating structure is less than the quotient of the given wavelength divided by five.

4. The polarization control device of claim 1 wherein filling fraction of the grating structure is between twenty and one hundred percent.

5. The polarization control device of claim 1 wherein each of the two or more metasurfaces have a thickness in range of λ/20 and λ/4, where λ is the given wavelength.

6. The polarization control device of claim 1 operates to rotate polarization state of light incident thereon.

7. The polarization control device of claim 1 operates to rotate polarization state of light incident thereon by a fixed angle independent of the angle of incidence.

8. The polarization control device of claim 1 operates to transmit light incident thereon as left-circular polarized in a first frequency band and to transmit the light incident thereon as right-circular polarized in a second frequency band, where the first frequency band does not overlap with the second frequency band.

9. The polarization control device of claim 1 is fabricated using additive manufacturing.

10. A half-wave plate operating on electromagnetic radiation at a given wavelength, comprising:
a backplate; and
two or more metasurfaces mounted on to a backplate, where the two or more metasurfaces are stacked directly onto each other without intermediate layers interposed between the two or more metasurfaces;
each of the two or more metasurface has a grating structure formed by two dielectric materials, where a ratio of permittivity exhibited by the two dielectric materials, a filling fraction of the grating structure, and thickness of each of the two or more metasurfaces are configured to rotate polarization state of the electromagnetic radiation incident thereon;
wherein periodicity of the grating structure is less than the given wavelength and orientation of the grating structure in each of the two or more metasurfaces differs from each other grating structures in the two or more metasurfaces.

11. The half-wave plate of claim 10 wherein the ratio of permittivity exhibited by the two dielectric materials is greater than four.

12. The half-wave plate polarization of claim 10 wherein the periodicity of the grating structure is less than the quotient of the given wavelength divided by five.

13. The half-wave plate of claim 10 wherein the periodicity of the grating structure is 1000 microns and the filling fraction of the grating structure is fifty percent.

14. The half-wave plate of claim 10 wherein the two dielectric materials are defined as alumina and air.

15. The half-wave plate of claim 10 wherein the backplate is comprised of copper.

16. The half-wave plate of claim 10 is fabricated using ceramic stereolithography.

17. A dual band circular polarizer, comprising:
two or more metasurfaces are stacked directly onto each other without intermediate layers interposed between the two or more metasurfaces;
each of the two or more metasurfaces has a grating structure formed by two dielectric materials, where a ratio of permittivity exhibited by the two dielectric materials, a filling fraction of the grating structure, and thickness of each of the two or more metasurfaces are configured to transmit light incident thereon as left-circular polarized in a first frequency band and to transmit the light incident thereon as right-circular polarized in a second frequency band, such that the first frequency band does not overlap with the second frequency band; and
wherein orientation of the grating structure in each of the two or more metasurfaces differs from each other grating structures in the two or more metasurfaces.

18. The dual band circular polarizer of claim 17 wherein the ratio of permittivity exhibited by the two dielectric materials is greater than four.

19. The dual band circular polarizer of claim 17 wherein the periodicity of the grating structure is less than the quotient of the given wavelength divided by five.

20. The dual band circular polarizer of claim 17 wherein the two or more metasurfaces is further defined as sixteen metalayers.

21. The dual band circular polarizer of claim 17 wherein the two dielectric materials are defined as alumina and air.

22. The dual band circular polarizer of claim 17 is fabricated using ceramic stereolithography.

23. An isotropic polarization rotator operating on electromagnetic radiation at a given wavelength, comprising:
two or more metasurfaces are stacked directly onto each other without intermediate layers interposed between the two or more metasurfaces;
each of the two or more metasurfaces has a grating structure formed by two dielectric materials, where a ratio of permittivity exhibited by the two dielectric materials, a filling fraction of the grating structure, and thickness of each of the two or more metasurfaces are configured to transmit electromagnetic radiation incident thereon and rotate polarization state of the transmitted electromagnetic radiation at a same rotation angle regardless of the polarization state of the electromagnetic radiation incident thereon;
wherein orientation of the grating structure in each of the two or more metasurfaces differs from each other grating structures in the two or more metasurfaces.

24. The isotropic polarization rotator of claim 17 wherein the ratio of permittivity exhibited by the two dielectric materials is greater than four.

25. The isotropic polarization rotator of claim 23 wherein the periodicity of the grating structure is less than the quotient of the given wavelength divided by five.

26. The isotropic polarization rotator of claim 23 wherein the two or more metasurfaces is further defined as nine metalayers.

27. The isotropic polarization rotator of claim 23 wherein the periodicity of the grating structure is 1100 microns.

28. The isotropic polarization rotator of claim 23 wherein the two dielectric materials are defined as alumina and air.
